(19) United States
(12) Patent Application Publication
(10) Pub. No.: US 2002/0079780 A1
(43) Pub. Date: Jun. 27, 2002

(54) Stator winding for electric motor

(75) Inventor: Jerzy Muszynski, Nashua, NH (US)

Correspondence Address: ROBERT V. VICKERS, VICKERS, DANIELS & YOUNG, Suite 2000, 50 Public Square, Cleveland, OH, 44113-2235, US

(73) Assignee: Cleveland Motion Controls, Inc. (an Ohio corporation)

(21) Appl. No.: 10/082,877

(22) Filed: Feb. 26, 2002

Related U.S. Application Data
(62) Division of application No. 09/483,985, filed on Jan. 18, 2000.

(51) Int. Cl. H02K 1/18

(52) U.S. Cl. 310/218

(57) ABSTRACT

A stator winding for mounting onto the stator core of an electric motor is provided with a base and a coil winding around the base and a connection portion for slidingly interengaging a corresponding slot in the stator. The base extends longitudinally between front and rear ends including a leg extending radially outwardly from a radially inner cross member to the connection portion and having circumferentially opposite sides with respect to the motor axis. A stator winding is assembled on the stator of an electric motor by providing a winding base with a connection portion adapted to engage a slot in the stator; providing a slot in the stator; winding an electrical conductor winding around the base; and slidingly interengaging the connection portion with the stator slot.

The present invention relates to the art of stator windings for electric motors and more particularly to a stator winding for mounting on an outlying stator core. The invention further relates to a method of assembling a stator winding to an outlying stator core of an electric motor.

### INCORPORATION BY REFERENCE

The following patents are hereby incorporated herein by reference as background information, as if fully reproduced herein: Behrend U.S. Pat. No. 931,375; Wieseman U.S. Pat. No. 2,655,613; Safranek U.S. Pat. No. 4,874,977; and Sonoda et al U.S. Pat. No. 5,057,733.

### BACKGROUND OF THE INVENTION

The present invention finds particular utility in connection with brushless reluctance motors a cylindrical outer stator encircling a cylindrical inner rotor. In stator configurations of this type a stator core typically includes winding teeth around which electrically conductive coil windings are wound. In operation, the coil windings are energized to produce stator poles. The stator teeth extend radially inward from the stator inner surface to tooth caps or pole caps which are either integral with the teeth or are removably mounted on the radially inner ends of the teeth.

Heretofore, coil windings have been wound around the stator teeth individually or in winding patterns with a coil pitch of more than one tooth, using either automated winding machines or by hand. In a multiple tooth pitch winding pattern, coil windings are simultaneously wound around two or more adjacent stator winding teeth. The typical winding machines are complicated devices capable of winding the coil windings around the teeth which are integral with the stator core. Adequate clearance for the winding process must be provided between the adjacent teeth for the machine to place the coil windings on the teeth. In general, the outer width of the coil windings on a given tooth is coextensive or slightly less than the corresponding width of the tooth cap. Existing winding machines for such motors with outer stators are well suited for winding patterns with a coil pitch of more than one tooth. In a multiple tooth pitch winding pattern, the winding end turns are longer than in a single tooth pattern. End turns in general do not contribute to torque generation, and increase the resistance of the overall winding. Consequently, minimizing the length of the end turns will improve the efficiency of the motor. The length of the end turns can be significantly decreased by using a single tooth pitch winding pattern. Newer winding machines capable of winding single tooth pitch patterns are being developed, but these are costly and complex, due to the tight spaces in which the machines must be operated. At the same time, it is desirable to minimize the slot openings between adjacent windings, to both increase the Carter coefficient and to reduce cogging; however, more complicated winding machinery is required to negotiate the narrow openings between slots. Alternatively, the stator teeth can be manually wound. However, the winding cost is increased in either case. Minimal slot openings are also desirable in providing for higher copper density, resulting in higher torque per volume capability and better heat transfer from the winding to the stator and the ambient environment. It is further desirable to maximize the amount of coil windings in the spaces between adjacent teeth. Motor efficiency is improved by increasing the copper density between adjacent teeth due to higher torque per unit volume and improved heat transfer from the windings to the stator core.

The use of removable tooth caps on outlying stator configurations provides some additional clearance for operation of a winding machine. The windings are wound onto the teeth prior to the installation of the caps. However, the clearance increase afforded by the use of removable caps is limited, and fails to allow maximum copper density between adjacent windings. Furthermore, the use of winding machines, or the alternative use of manual winding techniques, on the prior art outlying stator configurations are limited to operation within the interior of the stator core. Modular or prewound stator windings have been previously employed in inner stator configurations. Sonoda et al. U.S. Pat. No. 5,057,733 shows in FIGS. 2(a) and 2(b) an inner stator 7-1 with prewound pole members 7-3 inserted radially into the holes in the outer diameter of the stator 7-1. Safranek U.S. Pat. No. 4,874,977 discloses a bobbin lock clip for removably retaining a prewound coil bobbin on a pole leg of an electric alternator inner stator. In Safranek, the coil bobbin is prewound with coils separate from the overall stator assembly and subsequently installed radially onto a stator pole leg. These modular inner stator winding radial connection methods do not allow maximum utilization of the space between adjacent stator teeth for copper windings in an outlying stator configuration. In such configurations, radial mounting of a prewound stator winding or bobbin limits the width of the winding to the distance between the tooth caps of the two adjacent windings at the radially inner end of the windings. This leaves an unused gap between windings at the radially outer ends of the windings near the stator core inner surface. Similarly, the modular rotor winding arrangements of Behrend U.S. Pat. No. 931,375 and Wieseman U.S. Pat. No. 2,655,613 do not provide a cost effective method of maximizing the winding density in an outlying stator configuration. Behrend U.S. Pat. No. 931,375 is directed to the construction and arrangement of the field coils or windings on the rotatable element of high speed rotating field alternators. The coils 20 of FIGS. 4 and 5 are arranged around wedge shaped flanges radially aligned with respect to the rotor axis so that the centrifugal forces acting upon the windings will tend to hold the coils in position rather than to throw them out of position. This wedge shaped arrangement does not maximize the copper filling because of the radial alignment of the winding coils. Likewise, the radial attachment of prewound inner rotor windings in Wieseman U.S. Pat. No. 2,655,613 does not allow optimal coil density in an outlying stator configuration. An additional problem exists with respect to repair and/or replacement of existing stator windings. Prior stator winding configurations are difficult, if not impossible to remove or inspect in the field. It is therefore desirable to introduce an improved stator winding configuration and corresponding assembly method which provide reduced assembly costs and improved motor performance, as well as ease of maintenance in the field.

### SUMMARY OF THE INVENTION

In accordance with the present invention, there is provided a stator winding and a method of assembling a stator winding to an electric motor stator by which the foregoing and other problems and disadvantages are minimized or overcome. More particularly, and in accordance with the principle aspect of the present invention, there is provided a stator winding for an electric motor having an outlying stator comprising a base mountable on the stator and an electrical conductor circling the base which is wound thereon prior to being mounted on the stator core. This aspect of the invention provides removable mounting of a winding on a stator, allows smaller slot openings, and provides for higher copper density in the finished stator. Preferably, the base includes attachment means for slidingly interengaging with a corresponding slot in the stator core. In this regard, the electrical conductor coil winding is wound around the base using a simple, low cost winding machine, such as an ordinary bobbin winder, separate from the stator core, and is subsequently installed onto the stator core. Such sliding interengagement can be provided by a connection portion on the winding base which extends longitudinally thereof and is longitudinally slidingly interengaged with a corresponding slot in the stator core. This advantageously provides for easy maintenance in the field by virtue of the winding being removable from the stator core for inspection, cleaning, and/or replacement. The invention thus provides for ease of manufacturing and allows single tooth winding pitch patterns. In accordance with one embodiment, there is provided a connection member on the base having a protrusion radially spaced from the base, the protrusion being transversely wider than the transverse width of the connection member at the top edge, and the stator is provided with a mating slot. In accordance with another embodiment, there is provided a connection member on the base having a longitudinally tapered profile whereby the transverse width of the connection member is smaller at one longitudinal edge than at the other edge. In this embodiment, the corresponding stator slot is similarly tapered, thus providing for a fixed or predetermined winding orientation.

In accordance with another aspect of the invention, there is provided a method of assembling a stator winding on the inner surface of an electric motor stator, comprising the steps of providing a base; providing a slot in the stator; providing a connection portion on the base adapted to engage the stator slot; winding an electrical conductor around the base to provide a coil; and slidingly interengaging the connection portion of the base with the stator slot. By this method, a removably mountable stator winding is provided, the stator assembly time is greatly reduced, and the winding machine complexity and costs are greatly reduced. Furthermore, the desirable single tooth winding pitch patterns can be achieved in a cost effective manner, resulting in improved motor performance.

It is accordingly a primary object of the present invention to provide an improved stator winding by which winding time is reduced.

It is another object of the present invention to provide an improved stator winding of the type described above which allows the use of simple, low cost winding machines.

It is still another object of the present invention to provide an improved stator winding of the type described above which can be easily wound using a single tooth pitch winding pattern.

It is yet another object of the present invention to provide an improved stator winding of the type described above which can be easily removed from the stator core for inspection, cleaning, and/or replacement.

It is another object of the present invention to provide an improved stator winding of the type described above which allows smaller slot openings in a finished stator.

It is still another object of the present invention to provide an improved stator winding of the type described above by which higher copper density can be achieved.

It is another object of the present invention to provide an improved stator winding assembly method which reduces the winding and assembly time for electric motor stators.

It is another object of the present invention to provide a stator winding assembly method of the type described above which includes the use of simple, low cost winding machines.

It is still another object of the present invention to provide a stator winding assembly method of the type described above which provides a winding separate and apart from the stator core, and subsequent installation of the winding on the stator core.

It is still another object of the present invention to provide a stator winding and assembly method by which field maintenance, repair, and/or replacement of a stator winding is facilitated.

### BRIEF DESCRIPTION OF THE DRAWINGS

The foregoing and other objects and advantages will become apparent from the following description of a preferred embodiment of the present invention illustrated in the accompanying drawings in which:

FIG. 1 is a cross-sectional elevation view of a portion of a prior art electric motor stator;

FIG. 2 is a cross-sectional elevation view of a portion of a prior art stator;

FIG. 3 is a cross-sectional elevation view of a portion of an electric motor stator in accordance with the present invention;

FIG. 4 is a perspective view of a stator winding base in accordance with the invention;

FIG. 5 is a perspective view of the base in FIG. 4 and an electrically conductive coil winding thereon;

FIG. 6 is a perspective view of the stator winding of FIG. 5 installed in an electric motor stator core;

FIG. 7 is a plan view of a stator winding system in accordance with the present invention;

FIG. 8 is a side elevation view, partially in section, of the stator winding system of FIG. 7;

FIG. 9 is a perspective view of another embodiment of a stator winding according to the invention; and,

FIG. 10 is a perspective view of still another embodiment of a stator winding according to the invention.

### DESCRIPTION OF A PREFERRED EMBODIMENT

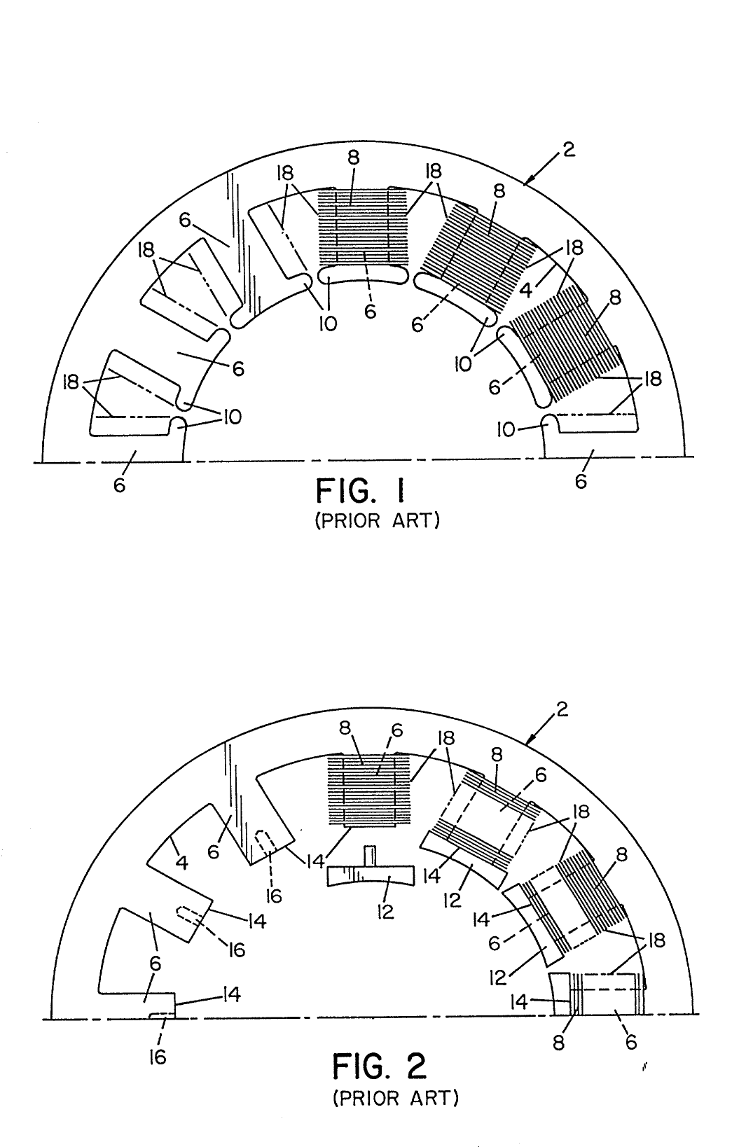

Referring now to the drawings wherein the showings are for the purpose of illustrating a preferred embodiment of the present invention only, and not for the purpose of limiting the same, FIGS. 1 and 2 illustrate existing stator configurations wherein a stator core 2 having a cylindrical inner surface 4 includes winding teeth 6 around which electrically conductive coil windings 8 are wound. The stator teeth shown in FIG. 1 extend radially inward from the stator inner surface 4 to tooth caps 10 which are integral with teeth 6. In the configuration of FIG. 2, tooth caps 12 are removably mounted on the radial inner ends 14 of teeth 6 using threaded fasteners, not shown, for engaging holes 16, or by other known fastening techniques. Coil windings 8 are wound around teeth 6 individually as shown in FIGS. 1 and 2, or in winding patterns with a coil pitch of more than one tooth, using winding machines, not shown. In a multiple tooth pitch winding pattern, coil windings 8 are simultaneously wound around two or more adjacent stator winding teeth 6. The typical winding machines are complicated devices capable of winding the coil windings 8 around the teeth 6 which are integral with the stator core 2. Adequate clearance for the winding process must be provided between the adjacent teeth 6 for the machine to place coil windings 8 on the teeth. In general, the outer width 18 of the coil windings 8 on a given tooth is coextensive or slightly less than the corresponding width of the tooth cap 10 or 12. The length of the end turns can be significantly decreased by using a single tooth pitch winding pattern thus reducing the overall winding resistance. Minimal openings between adjacent slots are also desirable in providing for higher copper density, resulting in higher torque per volume capability and better heat transfer from the winding to the stator and the ambient environment. In the prior art system of FIG. 2, the use of removable tooth caps 12 provides some additional clearance for operation of a winding machine over the system of FIG. 1. The windings 8 are wound onto the teeth 6 prior to the installation of caps 12. However, the clearance increase is limited. Furthermore, the use of winding machines, or the alternative use of manual winding techniques, on the prior art stator configurations are limited to operation within the interior of the stator core 2. Moreover, the prior stator winding configurations of FIGS. 1 and 2 are difficult, if not impossible, to remove or inspect in the field.

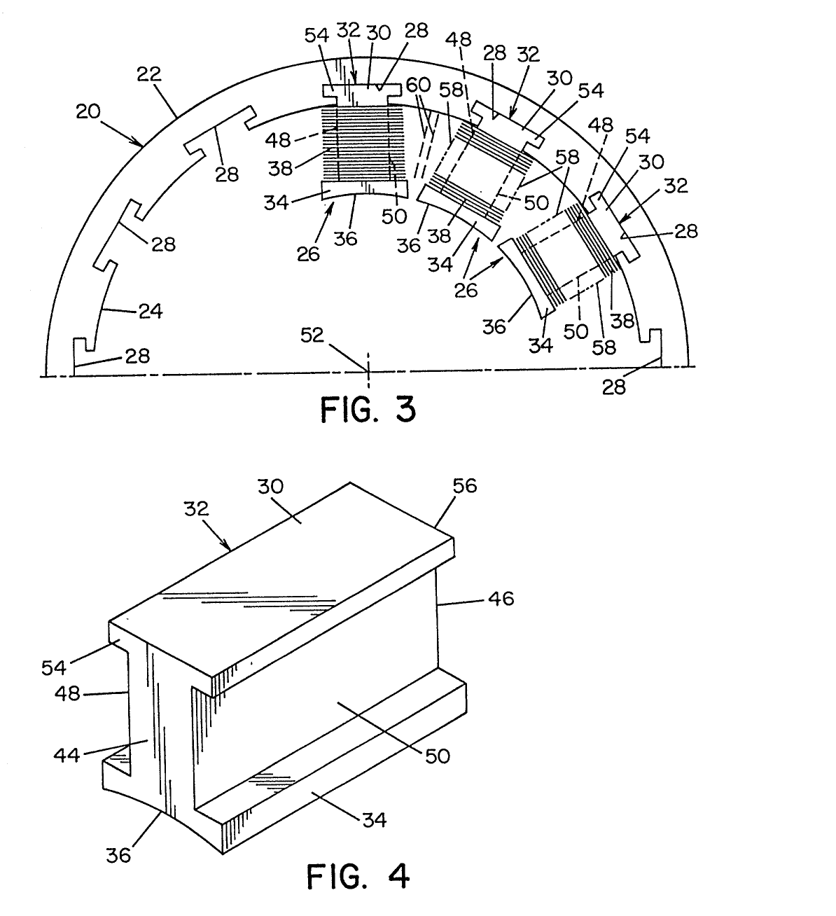

In accordance with a preferred embodiment of the present invention, FIG. 3 shows a portion of a cylindrical stator core 20 having cylindrical outer and inner surfaces 22 and 24, respectively, and stator windings 26, each comprising a base 32 having a T-shaped connection portion 30 engaging in a corresponding T-shaped slot 28 in core 20. Referring also to FIGS. 4-6, base 32 of stator winding 26 includes a cap portion 34 having a concave arcuate outer surface 36, and an electrically conductive coil winding 38. Coil winding 38 includes a fixed number of turns encircling base 32 around vertical longitudinally spaced front and rear ends 44 and 46, respectively, and laterally opposite sides 48 and 50 between connection portion 30 and cap 34, and the winding terminates in first and second winding ends 40 and 42, respectively. The number of turns of coil winding 38, and the dimensions and material of base 32 are determined according to the magnetic characteristics required of each pole in the finished stator. The concave surfaces 36 of caps 34 define an effective stator inner diameter within which a rotor, not shown, is rotatably mounted for rotation about an axis 52.

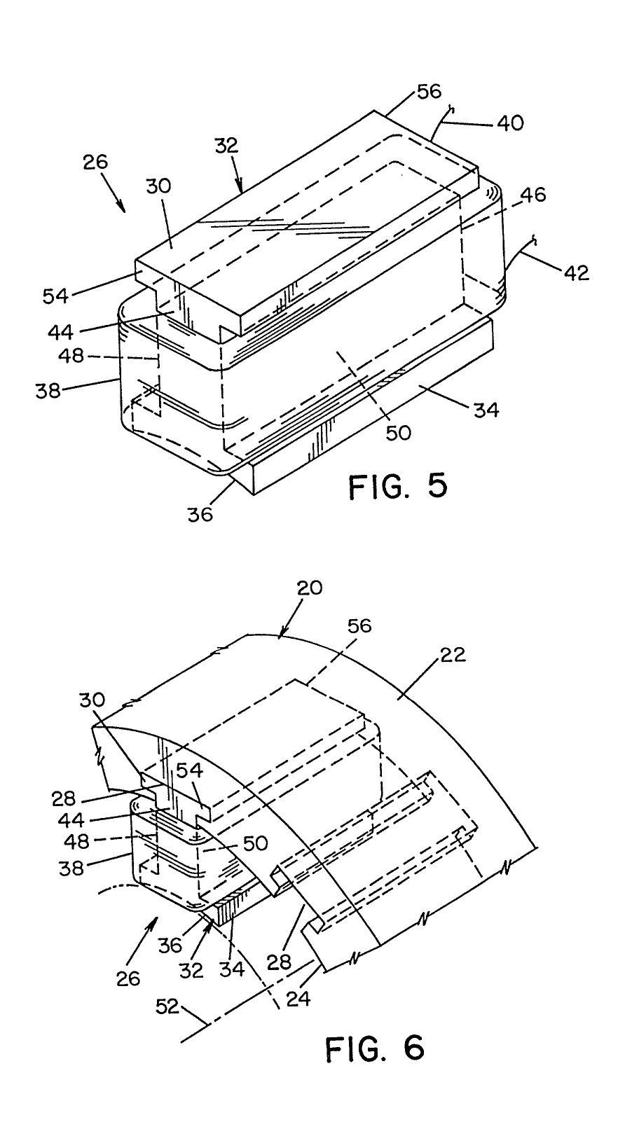

Base 32 in FIG. 4 is wound to create a stator winding 26 as shown in FIG. 5 and described further hereinafter. Individually wound stator windings 26 are then mounted on the inner surface 24 of stator core 20 by sliding the T-shaped connection portions 30 into T-shaped stator core slots 28 which are longitudinally parallel with axis 52. The connection portions 30 are fixed in position within the slots 28 using screws, not shown, or other fasteners, locking mechanisms, or adhesives which are known in the art. The profile of connection portions 30 and slots 28 is T-shaped in the drawings; however, it will be recognized that various profiles are possible, including but not limited to, triangular, L-shaped, J-shaped, Y-shaped, X-shaped, etc. In addition, the connection portion 30 of base 32 shown in FIG. 4 extends longitudinally between first edge 54 and second edge 56, having a constant T-shaped profile therebetween. It will be appreciated, however, that the profile of connection portion 32 and that of the corresponding slot 28 may be longitudinally tapered so as to predetermine the orientation of the first and second edges 54 and 56 with respect to the stator core 20. This could be used to ensure, for example, that all winding ends 40 and 42 are oriented to one longitudinal end of a finished stator to facilitate the interconnection thereof.

The longitudinal engagement of connection portions 30 with slots 28 further allows optimization of motor performance through minimization of the gap between adjacent poles and maximization of copper density. Referring to FIG. 3, caps 34 can be sized to minimize the distance between adjacent caps 34. Cogging effects are reduced and higher Carter coefficients are realized thereby, resulting in better motor efficiency. Copper density can be increased over prior configurations by utilizing a large portion of the area between adjacent bases 32 for additional windings 38. In the stator of FIG. 3, the electrically conductive coil windings 38 extend laterally of base 32 only to boundary 58, leaving a relatively large space between adjacent boundaries 58. This space could heretofore not be filled with coil windings. Moreover, this space could not be used if the stator windings 26 were radially installed into the stator core 20. By virtue of the longitudinal engagement of windings 26 with core 20, the coil windings 38 may be extended past boundary 58 which is parallel with the radial axis of the associated base 32 to boundary 60 which is itself radial with respect to axis 52. It will be appreciated that the actual boundary need not be radial or even linear; however, it is clear that a significant percentage of the heretofore unused gap between adjacent boundaries 58 can be utilized for placement of conductive coil windings 38 in accordance with the present invention. This higher winding density in turn increases the torque per unit volume capability for a given stator design and also improves the heat transfer from the winding to the stator and to the ambient environment.

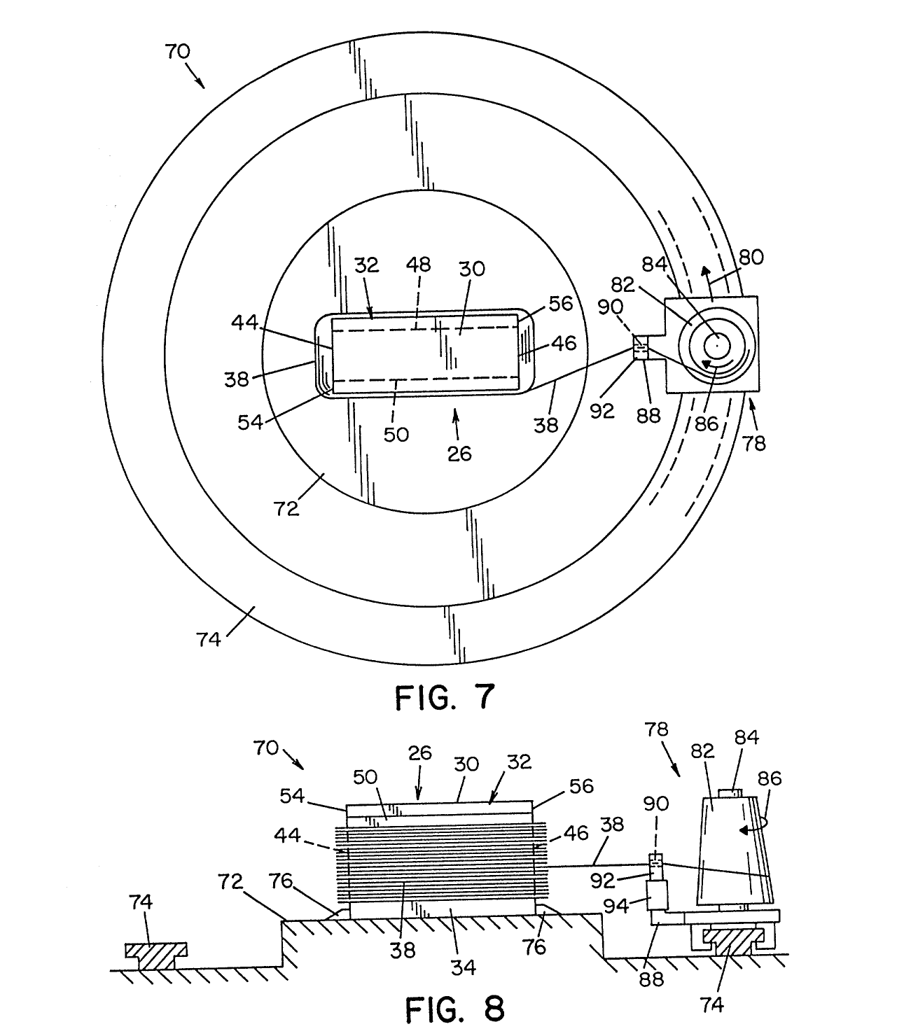

Referring now to FIGS. 7 and 8, the removable winding configuration of the present invention allows the employment of a simple method of winding coil 38 on base 32. In this respect, base 32 is installed on a bobbin winder 70 having a base clamping fixture 72 holding base 32 in a fixed location near the center of a circular bobbin track 74 using clamps 76. Electrically conductive coil winding 38 is wound around the front, rear, and sides 44, 46, 48, and 50 of base 32 by a bobbin device 78 which travels along track 74 in the direction indicated by arrow 80. Bobbin device 78 dispenses the conductor of coil winding 38 from a spool 82 which itself rotates around support 84 in the direction shown by arrow 86, through guide 88 to stator base 32. Guide 88 includes a feed hole 90 through guide arm 92 which can be selectively or automatically raised or lowered by ram 94 in order to controllably place the convolutions of coil winding 38 around base 32. Alternative winding mechanisms are conceivable within the scope of the invention, including but not limited to, fixed location rotating spools/coil guides adjacent fixed location rotating base fixtures and the like, not shown, which are known. The present invention allows the coil winding 38 to be wound around the base 32 to provide a stator winding 26 as shown in FIG. 5 separate and apart from the stator core 20. The stator winding is assembled on the inner surface 24 of stator core 20 by longitudinally slidingly engaging connection portion 30 within a stator core slot 28. Where a stator winding 26 is suspect, either during production testing, field maintenance, or elsewhere, provision of access to one or both ends of a finished motor will allow easy removal and/or replacement by merely sliding the winding 26 out of the slot 28. Cleaning, testing, and/or replacement of stator windings 26 are thus made relatively simple by the invention.

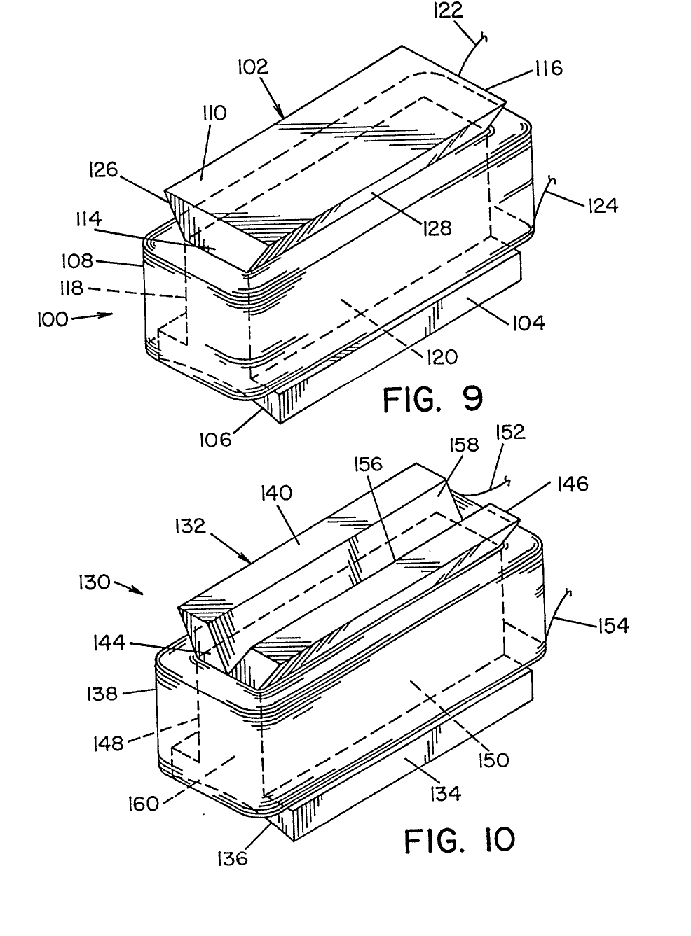

Other embodiments of the stator winding are possible within the scope of the present invention, examples of which are shown in FIGS. 9 and 10. In FIG. 9, a stator winding 100 includes a base 102 having a cap portion 104 with a concave arcuate outer surface 106 and an electrically conductive coil winding 108. Winding 108 includes multiple turns encircling base 102 around vertical longitudinally spaced front and rear ends 114 and 116, respectively, and laterally opposite sides 118 and 120 between a connection portion 110 and cap portion 104, and the winding terminates in first and second winding ends 122 and 124, respectively. Connection portion 110 includes angled longitudinal surfaces 126 and 128 extending between ends 114 and 116 to form a generally triangular longitudinal profile for longitudinally slidingly engaging with a corresponding stator slot, not shown, having a corresponding generally triangular longitudinal profile. Similarly, FIG. 10 shows a stator winding 130 having a base 132 with a cap portion 134 having a concave arcuate outer surface 136, and an electrically conductive coil winding 138. The winding 138 includes turns encircling base 132 around vertical longitudinally spaced front and rear ends 144 and 146, respectively, and laterally opposite sides 148 and 150 between a connection portion 140 and cap portion 134, and the winding 138 terminates in first and second winding ends 152 and 154, respectively. Arms 156 and 158 extend radially outwardly at an angle forming a Y shape with longitudinal leg 160. Connection portion 140 thus presents a V or Y shaped longitudinal profile for slidingly longitudinally interengaging with a corresponding V or Y shaped slot in a stator core, not shown.

As many possible embodiments of the present invention may be made, and as many possible changes may be made in the embodiment set forth herein, it is to be distinctly understood that the foregoing descriptive matter is to be interpreted merely as an illustration of specific embodiments of the invention, and not as a limitation thereof. It is therefore applicant's intent to include all embodiments within the scope of the accompanying claims and all equivalents thereof.

Having thus described the invention, the following is claimed:

1. A stator winding for mounting on an electric motor having a rotor mounted for rotation about a longitudinal axis within an outlying stator, said stator winding comprising:
a base having a leg with longitudinally spaced front and rear ends, radially outer and inner ends, and first and second circumferentially opposite sides;
an electrical conductor coil circling said base around said sides and said front and rear ends; and,
mounting means on said base and said stator for slidingly mounting said winding on said stator core.

2. The stator winding of claim 1, wherein said mounting means on said base is spaced radially outwardly from said radially inner end of said leg.

3. The stator winding of claim 2, wherein said mounting means on said base includes a connection portion on said radially outer end of said leg having radially spaced outer and inner ends and longitudinally spaced first and second ends, said connection portion being adapted to slidingly engage a corresponding slot in said stator.

4. The stator winding of claim 3, further including a pole cap at said radially inner end of said leg.

5. The stator winding of claim 4, wherein said pole cap is a flange extending circumferentially outwardly from opposite sides of said leg at said radially inner end of said leg.

6. The stator winding of claim 5, wherein said pole cap is removably mounted on said leg.

7. The stator winding of claim 1, wherein said mounting means on said base includes a connection portion on said radially outer end of said leg having radially spaced outer and inner ends and longitudinally spaced first and second ends, said connection portion being adapted to slidingly engage a corresponding slot is said stator.

8. The stator winding of claim 3, wherein said connection portion includes a circumferential protrusion with circumferentially opposite sides spaced radially outwardly from said radially inner end of said connection portion, at least one of said circumferentially opposite sides of said protrusion extending circumferentially outwardly beyond one of said first and second circumferentially opposite sides of said leg.

9. The stator winding of claim 8, wherein said connection portion is circumferentially wider at one of said longitudinally spaced first and second ends than at the other of said ends with a tapered longitudinal profile therebetween.

10. The stator winding of claim 3, wherein said connection portion is circumferentially wider at one of said longitudinally spaced first and second ends than at the other of said ends.

11. The stator winding of claim 7, wherein said connection portion has a trapezoidal profile in cross section.

12. The stator winding of claim 7, wherein said connection portion has a T-shaped profile in cross section.

13. The stator winding of claim 7, wherein said connection portion has a Y-shaped profile in cross section.

14. The stator winding of claim 1, wherein said mounting means includes a connection portion on said base having a cross sectional profile and a slot in said stator core having a cross sectional profile corresponding with said cross sectional profile of said connection portion.

15. The stator winding of claim 14, wherein said connection portion is spaced radially outwardly from said radially inner end of said leg.

16. The stator winding of claim 1, wherein said mounting means includes a connection portion on said leg and a longitudinally extending slot in said stator adapted to slidingly receive said connection portion, said connection portion and said slot including interengaging abutment surfaces adapted to prevent radial disengagement of said stator winding from said stator.

17. A method of assembling a stator winding on the stator core of an electric motor having a rotor mounted for rotation about a longitudinal axis within an outlying stator, comprising:
providing a base having a leg with longitudinally spaced front and rear ends, radially outer and inner ends, and first and second circumferentially opposite sides;
providing a slot in said stator;
providing a connection portion on said base adapted to slidably engage said slot;
winding an electrical conductor around said front and rear ends and said sides of said leg to provide a coil; and
slidingly interengaging said connection portion and said slot.

18. The method of claim 17, further including providing said connection portion with radially outer and inner ends and longitudinally spaced first and second ends.

19. The method of claim 18, further including providing said connection portion with a circumferential protrusion with circumferentially opposite sides spaced radially outwardly from said radially inner end of said connection portion, at least one of said circumferentially opposite sides of said protrusion extending circumferentially beyond one of said first and second circumferentially opposite sides of said leg.

20. The method of claim 18, further including providing said connection portion with a tapered longitudinal profile whereby said connection portion is circumferentially wider at one of said longitudinally spaced first and second ends than at the other of said ends.

21. The method of claim 19, further including providing said connection portion with a tapered longitudinal profile whereby said connection portion is circumferentially wider at one of said longitudinally spaced first and second ends than at the other of said ends.

22. The method of claim 17, further including providing a pole cap on said radially inner end of said leg.

23. A stator winding for mounting on an electric machine having a rotor mounted for rotation about a longitudinal axis within an outlying stator, said stator winding comprising:
a base including longitudinally spaced front and rear ends, a radially extending leg with radially outer and inner ends and circumferentially opposite sides, and a cross member spaced radially outwardly from said radially inner end of said leg;
an electrical conductor encircling said leg around said sides and said front and rear ends; and,
mounting means on said stator and said base for slidingly mounting said winding on said stator.

24. The stator winding of claim 23, wherein said mounting means includes a longitudinally extending slot in said stator adapted to slidingly receive said cross member.

25. The stator winding of claim 24, wherein said base further includes a pole cap mounted on said radially inner end of said leg.

26. The stator winding of claim 24, wherein said pole cap further includes a flange extending from said leg in circumferentially opposite directions.

27. The stator winding of claim 24, wherein said cross member has longitudinally spaced first and second ends.

28. The stator winding of claim 27, wherein said cross member is circumferentially wider at one of said first and second ends of said cross member than at the other said end.

29. The stator winding of claim 28, wherein said cross member has a longitudinally tapered profile between said first and second ends of said cross member.
